(19) United States
(12) Patent Application Publication
(10) Pub. No.: US 2004/0228057 A1
(43) Pub. Date: Nov. 18, 2004

(54) Overcurrent limit circuit

(75) Inventors: Shuji Mayama, Mie (JP); Isao Isshiki, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP)

(21) Appl. No.: 10/776,609

(22) Filed: Feb. 12, 2004

(30) Foreign Application Priority Data
Feb. 14, 2003 (JP) P2003-037248

(51) Int. Cl. H02H 3/00

(52) U.S. Cl. 361/100

(57) ABSTRACT

An overcurrent limit circuit including: a main function part which switches a drive current for a predetermined load between ON and OFF by an ON/OFF operation of a power-MOS-FET used as a drive switch, and which drives the power-MOS-FET and protects overcurrent; and a shunt-detection part which divides electric current applied to the drive switch from a power source side and detects the overcurrent, wherein the main function part, in case that the voltage between a drain of the power-MOS-FET and a source thereof is at least less than a predetermined threshold, has a function of limiting the electric current flowing in the power-MOS-FET on the basis of the overcurrent detected by the shunt-detection part.

### BACKGROUND OF THE INVENTION

1. Field of the Invention

This invention relates to an overcurrent limit circuit which is connected to a load and prevents an overcurrent.

2. Background Art

On an automobile, various car loads such as an engine load, a body electric load or a data load are mounted, and particularly a large number of various electric units functioning as car loads are mounted by recent development of electronic technology.

As shown in FIG. 3, by setting a fuse 4 on a current path 3 connecting a load 1 and a power source 2, various overcurrent protections has been performed till now (related art 1). In FIG. 3, reference numeral 5 is a mechanical relay.

However, in case that the above fuse 4 is used for overcurrent protection, when this fuse 4 blows frequently, work of exchanging the fuse is performed also frequently. Further, a fuse box in which the plural fuses 4 are unitized is generally used, volume of this fuse box is large, and mounting space of other car electric equipments is reduced. Further, in case that the exchanging work of the fuse 4 is taken into consideration, a mounting position of the fuse box is limited.

In view of these points, an overcurrent limit circuit using a semiconductive relay in place of the fuse box is also set.

Specifically, there are the following two methods as the overcurrent protecting method.

As one method, the overcurrent is detected by a shunt resistor, a sense or a MOS-FET, and judged by a microcomputer or in an external circuit (related art 2). In this case, rush current is taken care by reference voltage change in the external circuit or a software program of the microcomputer.

As the other method, as shown in FIG. 4, a self-protection type IPD (Intelligent Power Device) 6 having a current detecting function and a judgment function is used (related art 3).

The IPD 6 in this related art 3, as shown in FIG. 5, has is a self-protection type overcurrent protecting function of detecting that the overcurrent flows in the overcurrent limit circuit itself and that the temperature rises excessively and shutting off the electric current. In this case, the fuse 4 in FIG. 4 can be omitted.

In this IPD 6, as shown in FIG. 5, ON/OFF switching for drive of a load 11 is performed by a first switching element (drive switch) 12 composed of a power-MOS-FET.

Specifically, when an operator performs an ON/OFF switching operation using an operation switch 13, an input interface circuit 15 detects an ON/OFF state of the operation switch 13. When the input interface circuit 15 detects the ON state of the operation switch 13, a second switching element 17 as a FET becomes the ON state, so that power is applied to a protective logic circuit 21 and a charge pump 23 by a power source (+B) 19.

In this case, the charge pump 23, in order to keep a gate of the first switching element 12 at a higher electrical potential than a source thereof, increases the voltage of the power source (+B) 19 using an N channel FET and a capacitor for oscillation (for example twice).

At this time, a current limiter 25 judges whether a voltage drop between a drain and a source in the first switching element (drive switch) 12 exceeds the predetermined threshold. In case that the drain-to-source voltage drop in the first switching element 12 exceeds the predetermined threshold, the current limiter 25 short-circuits the gate-to-source intermittently to reduce input voltage to the gate, and reduces the electric current flowing in the first switching element 12.

This IPD 6 includes an overcurrent detecting circuit 29 which detects the overcurrent and informs the protection logic circuit 21 of the overcurrent, and an overtemperature detecting circuit 31 which detects the overtemperature and informs the protection logic circuit 21 of the overtemperature. The protection logic circuit 21, when the overcurrent detecting circuit 29 detects the overcurrent or the overtemperature detecting circuit 31 detects the overtemperature, cuts off or stops intermittently the supply of the gate voltage of the first switching element 12 through the charge pump 23 thereby to control the electric current and the temperature.

However, in case that surge current is produced in the load 11, a dynamic clamp circuit 27, in order to suppress overdrop of the voltage due to the negative surge caused by shutting-off of the current supply to the load 11, only while a negative surge is produced, switches on the first switching element 12 and protects each part in the overcurrent limit circuit.

When the overcurrent detecting circuit 29 detects the overcurrent or the overtemperature detecting circuit 31 detects the overtemperature, an OR circuit 33 judges OR of its output, switches on a third switching element 37 that is the FET, and informs an external alarm device (not shown) such as an alarm lamp of the overcurrent or the overtemperature by use of a pull-up resistor.

According to these related arts 2 and 3, the number of exchange of the fuse 4 that has been required till now is greatly reduced, and labor of the exchange is eliminated. Further, the fuse box itself can be omitted. In this case, the required mounting space can be reduced.

A reference relating to this invention is JP-A-2000-312433.

### SUMMARY OF THE INVENTION

In the above related art 2 type, the external circuit and the microcomputer cause increase of cost and increase of volume, so that the related art 2 type has not been practically prevailed yet.

On the other hand, in the related art 3 type, the used components are collected as the IPD 6. Therefore, volume efficiency is very good, and the cost is low.

However, in the related art 3 type, in case that the load 11 is in the overload state by short-circuit, its overload has not been surely detected and the IPD has not been completely protected.

Specifically, as described above, in case that whether the drain-to-source voltage drop in the first switching element 12 (drive switch) exceeds the predetermined threshold is judged, and the input voltage to the gate is reduced according to the result of its judgment, when the overcurrent is produced, the gate voltage of the first switching element 12 has been only dropped till now. Therefore, in the state where the drop of the drain-to-source voltage drop is large at the load short time, the current limit is not sufficient due to the characteristic of the drain current for the drain-to-source voltage in the switching element 12, so that there is fear of overpower break.

Further, in case of the- related art 3, before the drain-to-source voltage in the first switching element 12 becomes higher than the predetermined voltage, the current limiter 25 does not operate. Therefore, since the drain-to-source voltage in the first switching element 12 is small in the halfway. overcurrent state, the gate voltage is not limited. In case that a long time passes in this state, there is fear that the first switching element 12 is broken by the overcurrent.

Therefore, it is an object of the invention to provide an overcurrent limit circuit which can limit overcurrent properly also in case that a drain-to-source voltage in a drive switch is comparatively low.

In order to solve the above problems, according to the first aspect of the invention, an overcurrent limit circuit comprises: a main function part which switches a drive current for a predetermined load between ON and OFF by an ON/OFF operation of a power-MOS-FET used as a drive switch, and which drives the power-MOS-FET and protects overcurrent; and a shunt-detection part which divides electric current applied to the drive switch from a power source side and detects the overcurrent. Preferably, the main function part, in case that the voltage between a drain of the power-MOS-FET and a source thereof is at least less than a predetermined threshold, has a function of limiting the electric current flowing in the power-MOS-FET on the basis of the overcurrent detected by the shunt-detection part.

### BRIEF DESCRIPTION OF THE DRAWINGS

The present invention may be more readily described with reference to the accompanying drawings:

FIG. 1 is a block diagram showing an overcurrent limit circuit according to one embodiment of this invention;

FIG. 2 is a diagram showing a relation between drain-to-source voltage of a first switching element and drive current, and current limit reference;

FIG. 3 is a block diagram showing an overcurrent limit circuit according to related art 1;

FIG. 4 is a block diagram showing an overcurrent limit circuit according to related art 3; and

FIG. 5 is a block diagram showing an IPD of the overcurrent limit circuit according to the related art 3.

### DETAILED DESCRIPTION OF THE PREFERRED EMBODIMENTS

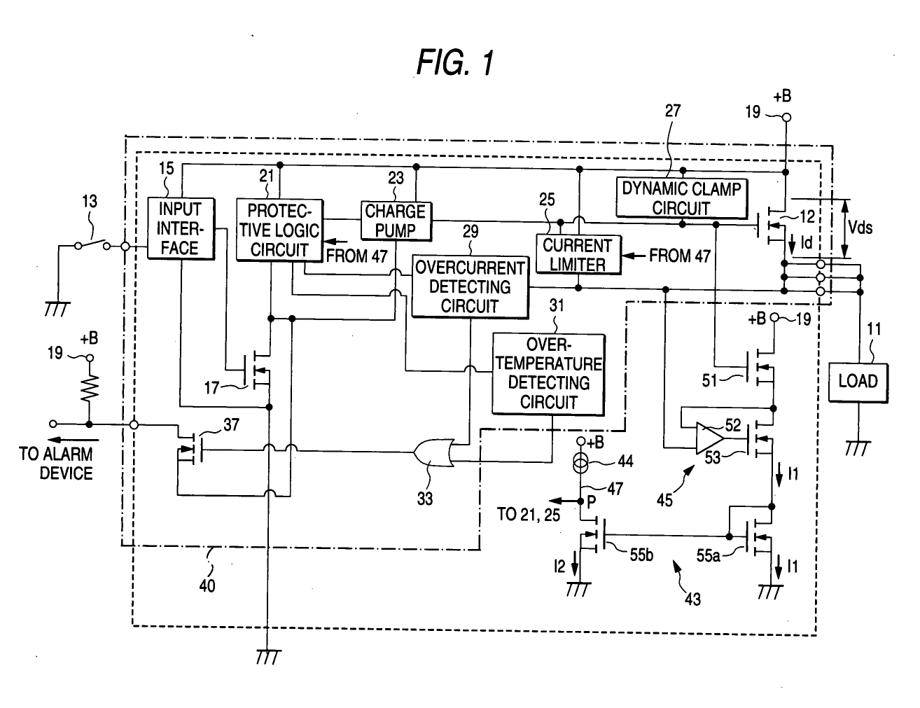

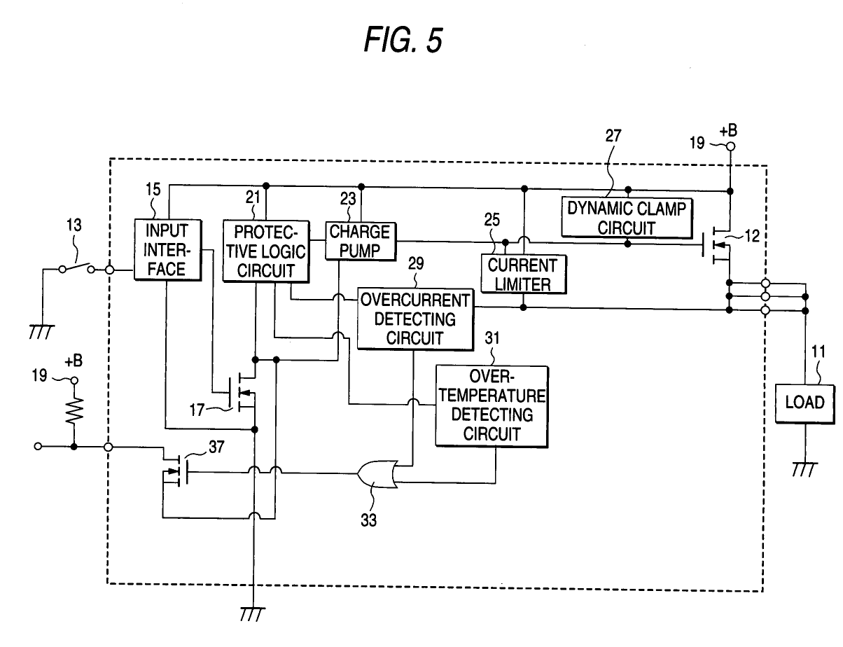

FIG. 1 is a block diagram showing an overcurrent limit circuit according to one embodiment of this invention. In this embodiment, parts similar to those in the related art 3 shown in FIG. 5 are denoted by the same reference numerals.

In this overcurrent limit circuit, as shown in FIG. 1, electric current on a drain side of a first switching element (drive switch) 12 is divided by a shunt circuit 45 connected to this first switching element 12 in parallel. Regarding this shunt current, by a current mirror circuit 43, only the electric current of a mirror ratio is caused to flow exactly to a constant current path 47 leading from another constant current source 44, and the first switching element 12 is protected from the overcurrent state according to the state of voltage drop on the constant current path 47 side.

Specifically, this overcurrent limit circuit comprises, in addition to a self-protection type overcurrent protection function part (hereinafter referred to as a main function part) 40 described in the related art 3, the shunt circuit 45 connected to the first switching element 12 in parallel, the current mirror circuit 43 connected on the downstream side of this shunt circuit 45, and the constant current source 44 which applies a constant current to the constant current path 47 located at one end side of the current mirror circuit 43.

The main function part 40 detects the overcurrent and the overtemperature inside the part 40 and adjusts drive current for a load 11. The main function part 40, similarly to that in the related art 3, comprises the first switching element (drive switch) 12, an input interface circuit 15, a second switching element 17, a protective logic circuit 21, a charge pump 23, a current limiter 25, a dynamic clamp circuit 27, an overcurrent detecting circuit 29, an overtemperature detecting circuit 31, and an OR circuit 33, and a third switching element 37.

The first switching element (drive switch) 12 uses a power-MOS-FET (field effect transistor) and performs ON/OFF switching of drive for the load 11.

The input interface circuit 15 detects an ON/OFF state of an operation switch 13 for performing an ON/OFF switching operation for drive of the load 11 by an operator.

The second switching element 17 uses a MOS-FET (MOS type field effect transistor), and enters an ON state when the input interface circuit 15 detects the ON state of the operation switch 13.

The protective logic circuit 21 operates upon reception of power from a power source (+B) 19. When the overcurrent detecting circuit 29 detects the overcurrent or the overtemperature detecting circuit 31 detects the overtemperature, the protective logic circuit 21 cuts off or stops intermittently (chops) supply of gate voltage of the first switching element 12 through the charge pump 23 on the basis of intermittent signals from each of these circuits 29 and 31 thereby to adjust the drive current Id for the load 11 and the temperature.

Further, this protective logic circuit 21 stops the supply of the gate voltage of the first switching element 12 on the basis of information signals given from a shunt-detection part 41 described later also when anything unusual is produced in the drive current for the load 11, and shuts off or chops the drive current Id for the load 11.

The charge pump 23, in order to keep a gate of the first switching element 12 at a higher electrical potential than a source thereof, increases the voltage of the power source (+B) 19 using an N channel FET and a capacitor for oscillation (for example, twice).

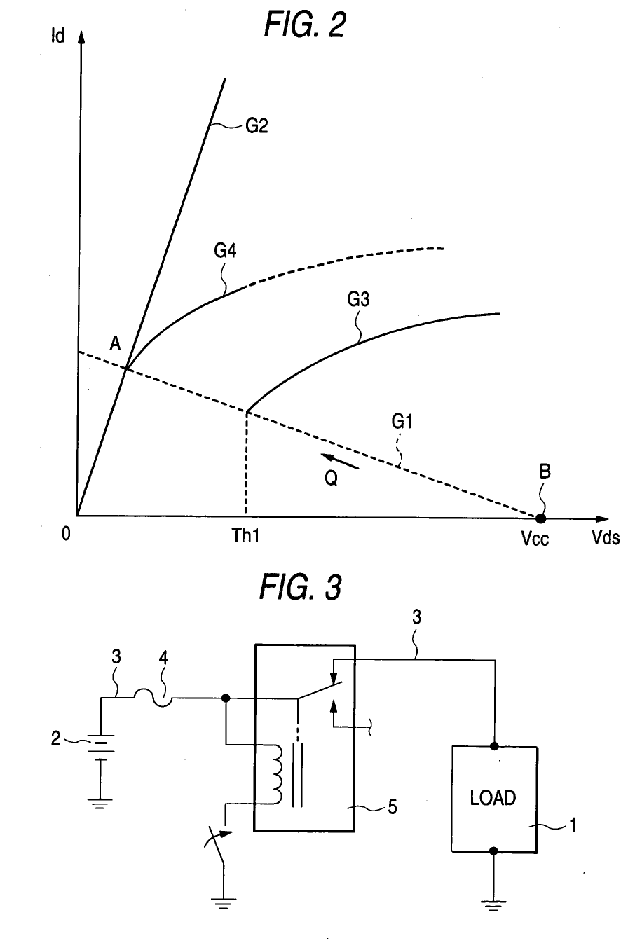

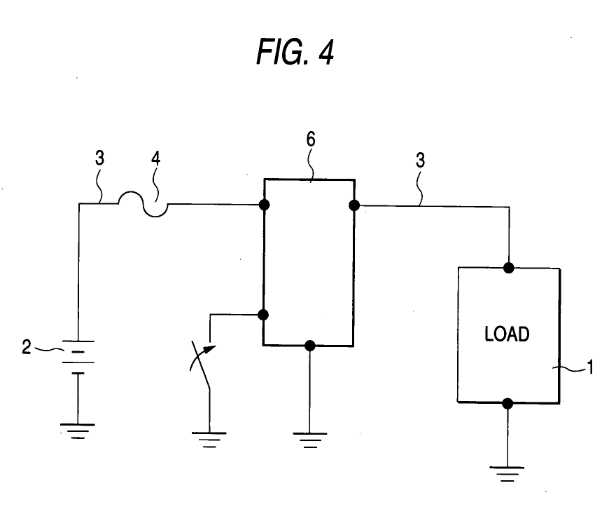

The current limiter 25, in case that the drain-to-source voltage drop (transverse axis Vds in FIG. 2) in the first switching element 12 exceeds the predetermined threshold Th1, short-circuits the gate-to-source intermittently, and reduces input voltage to the gate, whereby the electric current Id flowing in the first switching element 12 is reduced as shown by a first current limit curve G3 in FIG. 2.

The dynamic clamp circuit 27, in order to suppress, in case that shutting-off or chopping of the current supply to the load 11 is performed when surge current is generated, excessive decrease of voltage by negative surge, switches on the switching element 12 and protects each part in the overcurrent limit circuit.

The overcurrent detecting circuit 29 detects the overcurrent, and continues to transmit the predetermined signals to the protective logic circuit 21 intermittently while its overcurrent continues.

The overtemperature detecting circuit 31 detects the overtemperature, and continues to transmit the predetermined signals to the protective logic circuit 21 intermittently while its overtemperature continues. As this overtemperature detecting circuit 31, there are a latch type which requires a reset signal for reset when the overtemperature is released, and an automatic reset type which performs On-switching again in case that the temperature lowers. Any of these types may be used.

The OR circuit 33, when the overcurrent detecting circuit 29 has detected the overcurrent or the overtemperature detecting circuit 31 has detected the overtemperature, takes the logic sum of its output.

The third switching element 37 uses specifically a MOS-FET (MOS type field effect transistor), enters the ON-state on the basis of the output from the OR circuit 33 when the overcurrent detecting circuit 29 has detected the overcurrent or the overtemperature detecting circuit 31 has detected the overtemperature, and informs an external alarm device (not shown) such as an alarm lamp of the overcurrent or the overtemperature by use of a pull-up resistor.

The shunt circuit 45 divides the electric current from the source side of the first switching element 12 at the predetermined shunt ratio. The shunt circuit 45 comprises a sense MOS-FET 51 connected in parallel to the first switching element 12 used as the drive switch of the load 11, a differential amplifier (voltage adjusting unit) 52 to which a source of this sense MOS-FET 51 and a source of the first switching element 12 are input, and a current adjusting MOS-FET 53 which receives the output from this differential amplifier 52 as a gate voltage, and supplies the electric current from the source of the sense MOS-FET 51 to the current mirror circuit 43.

A part of the power-MOS-FET for constituting each switching element 12, 17, 37 is defined, and the defined region is assigned to the sense MOS-FET 51. The area rate of the sense MOS-FET 51 region to the switching element 12 is set to the predetermined value, whereby the electric current on the drain side of the first switching element 12 is divided at the shunt ratio of the sense MOS-FET 51 to the first switching element 12 (for example, one-ten thousandth). Further, the power source (+B) 19 connected to a drain of the sense MOS-FET 51 is the same as the power source (+B) 19 connected to a drain of the first switching element (drive switch) 12. Therefore, when the drive current Id flowing in the first switching element 12 increases or decreases, the electric current (shunt current) flowing in the sense MOS-FET 51 also increases or decreases at the same ratio.

The differential amplifier 52 changes the output voltage according to difference between the source voltage of the sense MOS-FET 51 and the source voltage of the first switching element 12. In case that the shunt ratio from the first switching element 12 changes unstably, the differential amplifier 52 functions so as to adjust the gate voltage of the current adjusting MOS-FET 53 thereby to adjust the shunt current I1.

The current adjusting MOS-FET 53, as described above, receives the output from the differential amplifier 52 as the gate voltage, and functions so as to adjust the shunt current I1 input from the sense MOS-FET 51 according to the gate voltage.

The current mirror circuit 43, using the fact that the electric current of the predetermined mirror ratio (for example, one-to-one) flows to a pair of MOS-FET's (field effect transistor) 55a and 55b which are formed symmetrically, causes mirror current I2 of the mirror rate to the electric current I1 flowing from the shunt circuit 45 to flow to the MOS-FET 55b.

As long as the constant current source 44 is the existing constant current source used generally, any constant current source may be used, for example, an attraction constant current type or an outflow constant current type using a transistor, a type using a constant current diode, or a type using three-terminal regulator.

The voltage of a drain (P point) of the MOS-FET 55b on the constant current path 47 side in the current mirror circuit 43 is detected, and whether the drive current Id flowing in the first switching element 12 is the overcurrent or not is judged, whereby it is possible to limit the overcurrent Id of the first switching element 12. Specifically, the voltage of the drain (P point) of the MOS-FET 55b is input to the protective logic circuit 21 and the current limiter 25, and the protective logic circuit 21 controls the charge pump 23 to perform chopping control of the first switching element 12, or the current limiter 25 short-circuits the gate-to-source of the first switching element 12, whereby the overcurrent Id of the first switching element 12 is limited.

As described above, the shunt circuit 45, the current mirror circuit 43 and the constant current power 44 function as a shunt-detection part which divides the electric current applied from the power source 19 side to the first switching element (drive switch) 12 and detects the overcurrent.

Next, the operation of this overcurrent limit circuit will be described.

Firstly, when an operator performs an ON/OFF switching operation with the operation switch 13, the input interface circuit 15 detects the ON/OFF state of the operation switch 13. When the input interface circuit 15 has detected the ON state of the operation switch 13, the second switching element 17 as the MOS-FET enters the ON state, and power is applied to the protective logic circuit 21 and the charge pump 23 by the power (+B) 19 to operate them.

In this case, the charge pump 23, in order to keep the gate of the first switching element 12 at a higher electrical potential than the source thereof, increases the voltage of the power source (+B) 19 (for example, twice).

In this case, the current limiter 25 judges whether the drain-to-source voltage drop (transverse axis Vds in FIG. 2) in the first switching element 12 exceeds the predetermined threshold Th1. In case that the drain-to-source voltage drop in the first switching element 12 exceeds the predetermined threshold Th1, the current limiter 25 short-circuits the gate-to-source of the first switching element 12 intermittently, and reduces input voltage to the gate, whereby the electric current Id flowing in the first switching element 12 is reduced as shown by the first current limit curve G3, in FIG. 2.

The overcurrent detecting circuit 29 detects the overcurrent in accordance with the predetermined reference on the basis of the predetermined current threshold. In case that the drive current is the overcurrent, the overcurrent detecting circuit 29 outputs signals indicating the overcurrent to the protective logic circuit 21.

In parallel with this operation of the overcurrent detecting circuit 29, the overtemperature detecting circuit 31 detects whether the temperature is excessive or not. In case that the temperature is excessive, the overtemperature detecting circuit 31 outputs signals indicating the overtemperature to the protective logic circuit 21.

When the overcurrent detecting circuit 29 detects the overcurrent or the overtemperature detecting circuit 31 detects the overtemperature, the protective logic circuit 21 cuts off or stops intermittently the supply of gate voltage of the first switching element 12 through the charge pump 23 thereby to adjust the electric current and the temperature.

However, in case that the surge current is generated in the load 11, dynamic clamp circuit 27, in order to suppress, in case that shutting-off or chopping of the current supply to the load 11 is performed, excessive decrease of voltage by the negative surge, functions so as to switch on the switching element 12 only while the negative surge is generated thereby to protect each part in the overcurrent limit circuit.

When the overcurrent detecting circuit 29 has detected the overcurrent or the overtemperature detecting circuit 31 has detected the overtemperature, the OR circuit 33 judges OR of its output, and the third switching element 37 is switched on thereby to inform the external alarm device (not shown) such as an alarm lamp of the overcurrent or the overtemperature by use of the pull-up resistor 35.

In the above operation, the limit of the drive current Id on the basis of the voltage Vds (drain-to-source voltage drop in the first switching element 12) is executed by the current limiter 25 only in case that the drain-to-source voltage drop Vds of the first switching element 12 is over the predetermined threshold Th1. However, in case that the drain-to-source voltage drop Vds of the first switching element 12 is lower than the predetermined threshold Th1 (or it is Th1 or less), the current limiter 25 does not perform the limit of the drive current Id.

Specifically, FIG. 2 shows a relation between the drain-to-source voltage Vds of the first switching element 12 in the circuit structure of FIG. 1 and the drive current Id, and the current limit reference. In FIG. 2, a transverse axis represents the drain-to-source voltage Vds of the first switching element 12, and a vertical axis represents the drive current Id flowing in the first switching element 12 in relation to the drain-to-source voltage Vds. Namely, a broken line G1 (load ideal line) in FIG. 2 shows an ideal relation between the drain-to-source voltage Vds of the first switching element 12 and the drive current Id in case that the durability of the switching element 12 and the load 11 is taken into consideration. Further, a line G2 (On-resistance line) shows On-resistance characteristic of the first switching element 12. Herein, it is assumed that the drive current Id does not exceed the On-resistance line G2 in FIG. 2 basically.

A stable point of the drain-to-source voltage Vds and the drive current Id when the first switching element 12 is switched on becomes an intersecting point of the load ideal line G1 and the On-resistance line G2. Namely, in case that the durability of the switching element 12 and the load 11 is taken into consideration, the value of the drain-to-source voltage Vds of the first switching element and the value of the drive current Id, as the on-state of the first switching element 12 is kept, change from a point B (Vds =Vcc (for example, 12V), Id=0) along the load ideal line G1 in the direction of an arrow Q, and become stabilized when they reach the stable point A.

The limit of the drive current Id by the current limiter 25 is shown by the first current limit curve G3 in FIG. 2 as described above. This first current limit curve G3, as described above, is applied only in case that the drain-to-source voltage drop Vds of the first switching element 12 is over the predetermined threshold Th1. Accordingly, in case that the drain-to-source voltage drop Vds of the first switching element 12 is lower than the predetermined threshold Th1 (or it is Th1 or less), the current limiter 25 stops the function of limiting the drive current Id.

However, as described above, it is ideally desirable that the value of the drain-to-source voltage Vds of the first switching element 12 and the value of the drive current Id, as the On-state of the first switching element 12 is kept, change from the point B along the load ideal line G1 in the direction of the arrow Q, and become stabilized when they reach the stable point A. Namely, it is desirable that when the On-state of the first switching element 12 goes on a degree, the drain-to-source voltage drop Vds of the first switching element 12 becomes lower than the predetermined threshold Th1 (or at least the predetermined threshold Th1). However, at this point of time, the situation in which the current limit on the basis of the voltage Vds by the current limiter 25 does not operate effectively occurs.

Therefore, in this embodiment, specially in case that the drain-to-source voltage drop Vds of the first switching element 12 is lower than the predetermined threshold Th1 (or at least Th1), the voltage at the point in FIG. 1 (drain voltage of the MOS-FET 55b on the constant current path 47 side) is detected by the shunt circuit 45, the constant current source 44, and the current mirror circuit 43, and the protective logic circuit 21 controls the charge pump 23 on the basis of this detection result thereby to perform chopping control of the first switching element 12, or the current limiter 25 short-circuits the gate-to-source of the first switching element 12, whereby the overcurrent Id of the first switching element 12 is limited.

Specifically, in accordance with the drive current Id flowing in the first switching element 12, the shunt current I1 according to the predetermined shunt ratio flows in the sense MOS-FET 51. In this time, while the differential amplifier 52 changes the output voltage correspondingly to the difference between the source voltage of the sense MOS-FET 51 and the source voltage of the first switching element 12, in case that the shunt ratio from the first switching element 12 changes unstably, the differential amplifier 52 adjusts the gate voltage of the current adjusting MOS-FET 53. The current adjusting MOS-FET 53 receives the output from the differential amplifier 52 as the gate voltage, and adjusts the shunt current I1 input from the sense MOS-FET 51.

This shunt current I1 is applied to one MOS-FET 55a of the current mirror circuit 43.

At this time, to the other MOS-FET 55b on the constant current path 47 side, the mirror current I2 of the mirror ratio previously set for the shunt current I1.

Since the constant current source 44 located on the upstream side of the constant current path 47 has only a fixed current capacity, if the mirror current I2 is the overcurrent, when the other MOS-FET 55b is going to cause the large mirror current I2 to flow under this overcurrent state, the drain voltage (voltage at the P point) of the other MOS-FET 55b drops from the +B voltage.

Therefore, when the drain voltage of the other MOS-FET 55b is observed, the overcurrent state of the shunt current I1 can be detected, so that the overcurrent Id flowing in the first switching element 12 and the load 11 can be detected.

By judging whether the drive current Id flowing in the first switching element 12 is the overcurrent or not by use of this voltage at the P point, it is possible to limit the over current Id of the first switching element 12. Specifically, the voltage of the drain (P point) of the MOS-FET 55b is input to the protective logic circuit 21 and the current limiter 25, and the protective logic circuit 21 controls the charge pump 23 to perform chopping control of the first switching element 12, or the current limiter 25 short-circuits the gate-to-source of the first switching element 12, the overcurrent Id of the first switching element 12 is limited.

A curve G4 (second current limit curve) in FIG. 2 represents a control curve of the overcurrent Id on the basis of the detection result of the voltage at the P point. In this case, in the protective logic circuit 21 and the current limiter 25, the relation between the voltage at the P point and the drive current Id in the first switching element 12 is previously included as data. The second current limit curve G4 in FIG. 2 is set so that it passes through the A point that is the ideal stable point, realize the higher drive current Id than the load ideal line G1, and realize the lower drive current Id than the On-resistance line G2.

In this embodiment, in addition to the current limit by the current limiter 25 on the basis of the drain-to-source voltage drop Vds of the first switching element 12, the current limit is executed, on the basis of the voltage at the P point detected by the shunt circuit 45, the current mirror circuit 43 and the constant current source 44, also in the region of the comparatively low voltage Vds which could not be detected in the related art 3. Therefore, the overcurrent limit can be properly performed regarding the first switching element 12 and the load 11.

In case that the drain-to-source voltage drop Vds in the first switching element 12 is large, only by the current limit in the second current limit curve G4, there is fear that large electric current flows in the first switching element. Therefore, as described above, in addition to the current limit by the current limiter 25 on the basis of the voltage Vds, which has been executed in the related art 3, particularly in case that the voltage Vds is the threshold Th1 or less, it is effective that the current limit in the second current limit curve G4 is executed. In this case, when the drain-to-source voltage drop Vds in the first switching element 12 is over the threshold Th1, the current limit on the basis of the voltage at the P point detected by the shunt circuit 45, the current mirror 43, and the constant current source 44 may be continued or may be stopped.

According to an aspect of the invention, when ON/OFF switching of the drive current for the predetermined load is performed by the ON/OFF operation of the power-MOS-FET used as the drive switch, the electric current applied from the power source side to the drive switch is divided thereby to detect the overcurrent, and the electric current flowing in the power-MOS-FET is limited on the basis of this overcurrent. Therefore, also in the region of the comparatively low voltage, which could not be detected in the related art 3, the current limit can be executed. Accordingly, the overcurrent limit can be properly performed on the drive switch and the load.

In this case, in case that the drain-to-source voltage of the power-MOS-FET is over the predetermined threshold, when the electric current flowing in the power-MOS-FET is limited in addition, the overcurrent can be limited more accurately.

According to another aspect of the intention, when the shunt current divided by the shunt circuit is applied to one side of the current mirror circuit, the mirror current of the mirror ratio previously set for this shunt current flows to the other side. In the path on this other side, since the constant current source has only the fixed current capacity, if the mirror current is the overcurrent, when the constant current source is going to cause the large mirror current to. flow under this overcurrent state, the voltage at the detection point cannot help dropping. Therefore, it is possible to detect the overcurrent state of the shunt current on the basis of the voltage at this detection point, and further to detect readily the overcurrent flowing in the drive switch and the load.

In the shunt circuit, the shunt ratio can be readily determined by the area rate of a pair of power-MOS-FET's, including the power-MOS-FET connected to the drive switch in parallel.

What is claimed is:

1. An overcurrent limit circuit comprising:
a main function part which switches a drive current for a predetermined load between ON and OFF by an ON/OFF operation of a power-MOS-FET used as a drive switch, and which drives the power-MOS-FET and protects overcurrent; and
a shunt-detection part which divides electric current applied to the drive switch from a power source side and detects the overcurrent,
wherein the main function part, in case that the voltage between a drain of the power-MOS-FET and a source thereof is at least less than a predetermined threshold, has a function of limiting the electric current flowing in the power-MOS-FET on the basis of the overcurrent detected by the shunt-detection part.

2. The overcurrent limit circuit according to claim 1,
wherein the main function part further has a function of limiting the electric current flowing in the power-MOS-FET by chopping, in case that the voltage between the drain and the source of the power-MOS-FET is over the predetermined threshold.

3. The overcurrent limit circuit according to claim 1, wherein the shunt-detection part comprises:
a shunt circuit for dividing the electric current applied to the drive switch from the power source side at a predetermined shunt ratio;
a current mirror circuit, one path of which a shunt current divided in the shunt circuit flows, and the other path of which a mirror current having a predetermined mirror ratio to the shunt current is obtained;
a constant current source being set onto the other path of the current mirror circuit;
the shunt circuit includes:
a sense MOS-FET, a gate and a drain of which are connected to the drive switch in common; and
a differential amplifier, to which a source voltage of the sense MOS-FET and a source voltage of the drive switch are input;
and
a detecting point of the overcurrent in the shunt-detection part is set to an intermediate point on the other path connecting the constant current source and the current mirror circuit.

4. The overcurrent limit circuit according to claim 2, wherein the shunt-detection part comprises:
a shunt circuit for dividing the electric current applied to the drive switch from the power source side at a predetermined shunt ratio;
a current mirror circuit, one path of which a shunt current divided in the shunt circuit flows, and the other path of which a mirror current having a predetermined mirror ratio to the shunt current is obtained:
a constant current source being set onto the other path of the current mirror circuit;
the shunt circuit includes:
a sense MOS-FET, a gate and a drain of which are connected to the drive switch in common; and
a differential amplifier, to which a source voltage of the sense MOS-FET and a source voltage of the drive switch are input;
and
a detecting point of the overcurrent in the shunt-detection part is set to an intermediate point on the other path connecting the constant current source and the current mirror circuit.

5. The overcurrent limit circuit according to claim 1, wherein the main function part comprises:
a current limiter for limiting the current flowing in the power-MOS-FET, in case that the voltage between the drain and the source of the power-MOS-FET is over a predetermined threshold; and
a protective logic circuit for limiting the current flowing in the power-MOS-FET by shutting off or chopping the drive switch;
and
the main function part has a function of limiting the current flowing in the power-MOS-FET on the basis of the detection result through the protective logic circuit or the current limiter, in case that the shunt-detection part has detected the overcurrent.

6. The overcurrent limit circuit according to claim 2, wherein the main function part comprises:
a current limiter for limiting the current flowing in the power-MOS-FET, in case that the voltage between the drain and the source of the power-MOS-FET is over a predetermined threshold; and
a protective logic circuit for limiting the current flowing in the power-MOS-FET by shutting off or chopping the drive switch;
and
the main function part has a function of limiting the current flowing in the power-MOS-FET on the basis of the detection result through the protective logic circuit or the current limiter, in case that the shunt-detection part has detected the overcurrent.

7. The overcurrent limit circuit according to claim 3, wherein the main function part comprises:
a current limiter for limiting the current flowing in the power-MOS-FET, in case that the voltage between the drain and the source of the power-MOS-FET is over a predetermined threshold; and
a protective logic circuit for limiting the current flowing in the power-MOS-FET by shutting off or chopping the drive switch:
and
the main function part has a function of limiting the current flowing in the power-MOS-FET on the basis of the detection result through the protective logic circuit or the current limiter, in case that the shunt-detection part has detected the overcurrent.

8. The overcurrent limit circuit according to claim 4, wherein the main function part comprises:
a current limiter for limiting the current flowing in the power-MOS-FET, in case that the voltage between the drain and the source of the power-MOS-FET is over a predetermined threshold; and
a protective logic circuit for limiting the current flowing in the power-MOS-FET by shutting off or chopping the drive switch;
and
the main function part has a function of limiting the current flowing in the power-MOS-FET on the basis of the detection result through the protective logic circuit or the current limiter, in case that the shunt-detection part has detected the overcurrent.
